(19) United States
(12) Patent Application Publication
(10) Pub. No.: US 2019/0224698 A1
(43) Pub. Date: Jul. 25, 2019

(54) SPRINKLER WITH ADJUSTABLE AREA OF COVERAGE

(71) Applicant: Meridian International Co., Ltd., Songjiang (CN)

(72) Inventor: Brent CHRISTOPHER, Centennial, CO (US)

(21) Appl. No.: 15/878,596

(22) Filed: Jan. 24, 2018

(51) Int. Cl. B05B 3/02; B05B 3/06

(52) U.S. Cl. CPC B05B 3/021; B05B 3/06

(57) ABSTRACT

A base with a supply connection for connecting the base to a water supply. A distributor head is revolvubly mounted to the base for rotating with respect to the base. There are at least two jet arms rotatably combined to the distributor head. Each of the jet arms comprises of at least one jet nozzle in fluid communication with the supply connection for disbursing water from the water supply. The jet arms are each rotatable to change the area of coverage of the sprinkler.

### TECHNICAL FIELD

This invention relates to sprinklers, and more specifically to sprinklers with manually adjustable coverage areas.

### BACKGROUND OF THE INVENTION

Lawn sprinklers and related devices receive water under pressure and convert its potential energy to kinetic energy; and their spreading range depends on the kinetic energy of the issuing jets. Conventional revolving sprinklers perform the conversion directly through their nozzles. Having a single moving part (the distributor head mounted on a trunnion), they are mechanically very simple, easy to manufacture and use, rugged, smooth and even in their spreading operation. What these sprinklers suffer from is an inability to control the area of coverage.

A sprinkler combining the simplicity and evenness of coverage with an adjustable coverage area would serve a useful purpose.

### SUMMARY OF THE INVENTION

Disclosed is a sprinkler with an adjustable area of coverage. The sprinkler comprises of a base with a supply connection for connecting the base to a water supply. A distributor head is revolvubly mounted to the base for rotating with respect to the base. There are at least two jet arms rotatably combined to the distributor head. Each of the jet arms comprises of at least one jet nozzle in fluid communication with the supply connection for disbursing water from the water supply. The jet arms are each rotatable to change the area of coverage of the sprinkler.

Each of the at least two jet arms is bent to a predetermined radius. The nozzles on each of the jet arms are on the same side as an inner diameter of the radius. The nozzles can be adjusted to the desired angle of inclination for the desired coverage area.

The distributor head can further comprise at least two oppositely extending shoulders each comprising an indicator window for communicating a representation of the area of coverage of the sprinkler. Each of the at least two jet arms further comprises a representation of the area of coverage of the sprinkler that is alignable with the indicator window of the oppositely extending shoulders. Rotation of the at least two jet arms changes the relative position of the representation of the area of coverage of the sprinkler with respect to the indicator window. The jet arms can be attached to the distributor by a compression tube fitting and easily rotated to the desired position.

### BRIEF DESCRIPTION OF THE DRAWINGS

FIG. 1A shows a perspective view of a sprinkler according to this disclosure.

FIG. 1B shows a close up view of area A-A of FIG. 1A showing an indicator window on near the jet arm of the sprinkler.

FIG. 1C shows a side view of the sprinkler from the perspective 1C of FIG. 1A.

FIG. 2 shows a cross-sectional view taken along the line of the same name FIG. 1A.

FIG. 3 shows a cross-sectional view taken along the line of the same name FIG. 1A.

### DESCRIPION OF THE ILLUSTRATED EMBODIMENTS

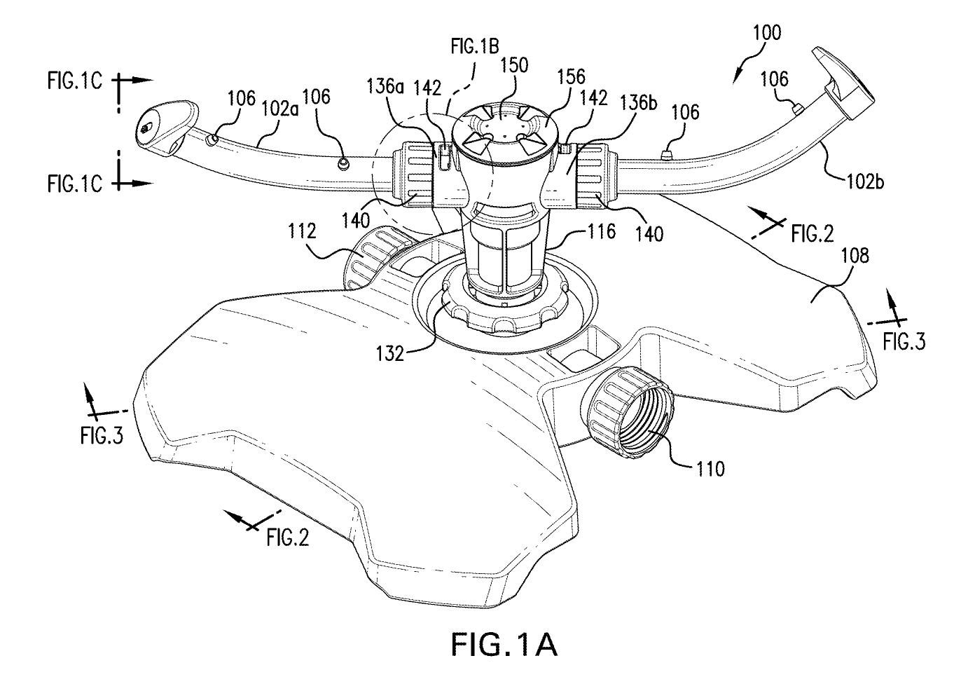

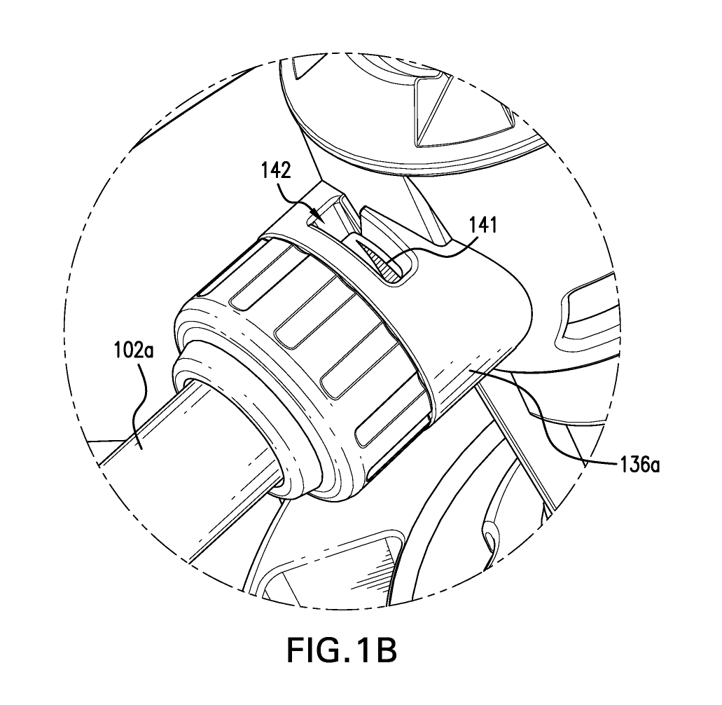

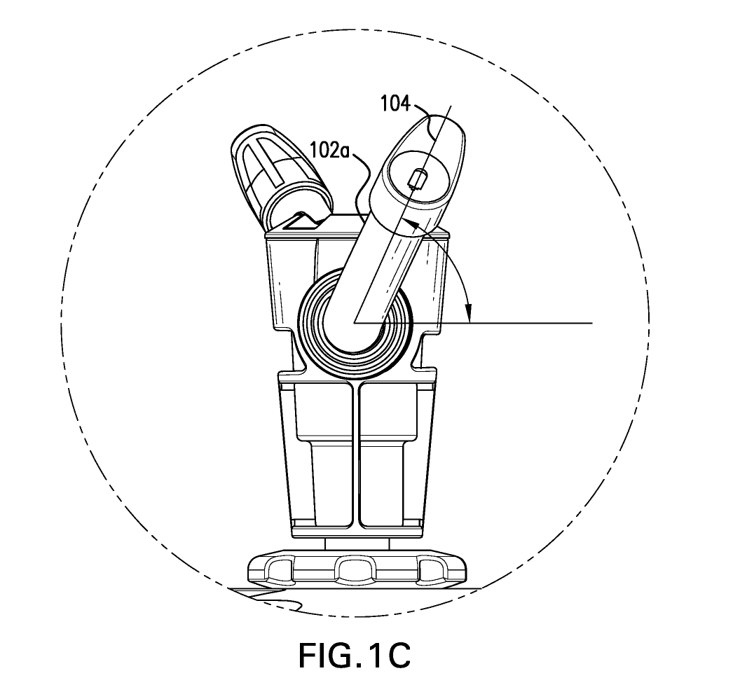

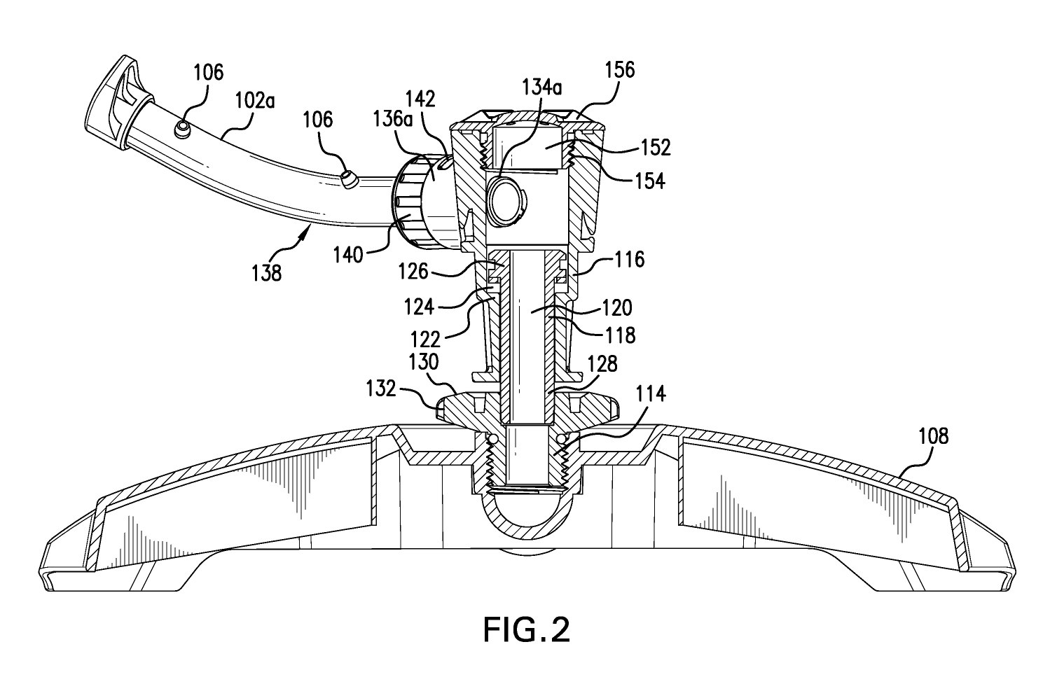

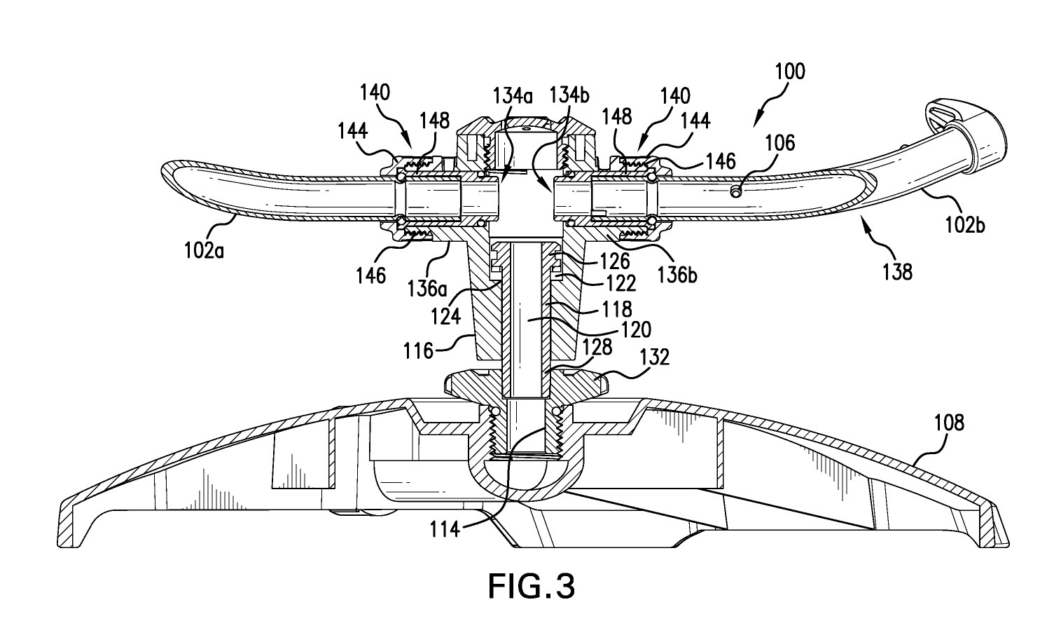

FIGS. 1-3 show a sprinkler 100 according to this disclosure. Sprinkler 100 differs from conventional sprinklers in that it has a manually adjustable area of coverage. Simply rotating jet arms 102a, 102b adjusts an angle of inclination 104 of nozzles 106, which is inversely proportional to the area of coverage of sprinkler 100. The smaller angle of inclination 104 is, the wider the coverage area. Conversely, the larger angle of inclination 104, the smaller the coverage area. For clarity, angle of Inclination 104 is measured between an imaginary line extending from nozzles 106 and a line parallel to the ground. In this regard, angle of inclination 104 can range from zero degrees (i.e., horizontal) to ninety degrees (i.e., vertical) and can be any value in between. In one exemplary embodiment, the preferred angle of inclination 104 is between thirty and seventy degrees, inclusive.

More specifically, sprinkler 100 comprises of a base 108. Base 108 can be stationary, as illustrated, or, can be movable with a pair of wheels mounted thereon, or can be in the form of a semi-permeant or permanent stake that is stuck into the ground. For this disclosure, any style of base will suffice. Base 108 comprises of a supply connection 110 for connecting base 108 to a water supply. Base 108 can also comprise an outlet connection 112 so that sprinkler 100 can be connected in series to another sprinkler where outlet connection 112 is directly connected by a hose to a supply connection of another sprinkler. When not in use, outlet connection 112 can be sealed with a cap. In between the inlet from supply connection 110 and outlet connection 112 in the interior of base 108 is an upward extending channel 114 to provide a path of fluid communication between supply connection 110 up and out base 108.

A distributor head 116 is revolvubly mounted on base 108 by a trunnion 118. Distributor head 116 comprises of an interior area 120 through its center. Inside interior area 120 is an inner shoulder 122 with a reduced friction surface 124. Trunnion 118 comprises of a trunnion head 126 at one end and a cylindrical end 128 at the other end. Trunnion head 126 rests on reduced friction surface 124 on inner shoulder 122 inside distributor head 116 for smooth rotation. Cylindrical end 128 of trunnion 118 is combined to upward extending channel 114 of base 108 by a compression fitting 130 that is sealed by a nut 132. This arrangement provides a revolvubly mounted distributor head 116 with 360 degree rotation while simultaneously providing a path of fluid communication from supply connection 110 through interior area 120 of distributor head 116.

On an upper end of distributor head 116 is at least two lateral discharge orifices 134a, 134b, each of which corresponds with one of at least two shoulders 136a, 136b. At least two shoulders 136a, 136b can be oppositely extending from each other. Lateral discharge orifices 134a, 134b provide a path for fluid communication out distributor head 116 into corresponding jet arms 102a, 102b. Jet arms 102a, 102b are hollow tubes that each comprises at least one nozzle 106. Nozzles 106 are each in fluid communication with supply connection 110 for disbursing water from the water supply.

Jet arms 102a, 102b are combined to corresponding shoulders 136a, 136b of distributor head 116 by a compression tube fitting 140. Compression tube fitting 140 comprises of a compression nut 144 with threads that allow compression nut 144 to be drawn up on corresponding shoulder threads 146 on respective shoulders 136a, 136b. Compression nut 144 has a sleeve 148 that is releasably compressible on the hollow tubes that comprise the respective jet arms 102a, 102b. Jet arms 102a, 102b can be easily rotated to adjust angle of inclination 104.

Each of jet arms 102a, 102b has a bend 138 with a radius 139. Nozzles 106 on the corresponding jet arms 102a, 102b are on the same side as an inner diameter of the radius, as shown. As previously discussed, each of the jet arms 102a, 102b is rotatable to adjust angle of inclination 104 of nozzles 106. Angle of inclination 104 is inversely proportional to the area of coverage of sprinkler 100. The smaller angle of inclination 104, the wider the coverage area. Conversely, the larger angle of inclination 104, the smaller the coverage area. This configuration provides an easily adjustable coverage area for sprinkler 100.

An indicator window 142 can be provided on each of shoulders 136a, 136b of distributor head 116. Indicator window 142 is a viewing area through respective shoulders 136a, 136b to an outer surface of corresponding jet arms 102a, 102b for communicating a representation of the area of coverage of the sprinkler 100. Each of jets arms 102a, 102b can be marked with a representation of the area of coverage 141 of sprinkler 100 that is alignable with the corresponding indicator window 142 of the respective shoulders 136a, 136b. In this manner, rotation of jet arms 102a, 102b changes the relative position of representation of the area of coverage 141 of sprinkler 100 with respect to the corresponding indicator window 142. This allows the operator to align the respective jet arms 102a, 102b to the appropriate area of coverage.

Distributor head 116 can further comprise at least one discharge orifice 150 at a top of distributor head 116 to cover an area in the immediate proximity of sprinkler 100. Water discharges upwardly from distributor head 116 to cover the immediately surrounding area. In this regard, distributor head 116 can further comprise of an opening 152 in a top with a threaded surface 154 and a threaded cap 156 that engages threaded surface 154 of opening 152 in the top of distributor head 116. This threaded cap 156 can have at least one discharge orifice 150 in the top of threaded cap 156. The illustrated embodiment shows four discharge orifices 150 evenly spaced around the top of threaded cap 156 for a more even distribution of water in the immediate proximity of sprinkler 100.

The Various aspects of any of the embodiments can be combined in different combinations than the ones shown to create new embodiments that fall within the scope of the appended claims.

While the present invention has been particularly shown and described with reference to exemplary embodiments thereof, it should be understood by those of ordinary skill in the art that various changes, substitutions and alterations can be made herein without departing from the scope of the invention as defined by appended claims and their equivalents. The invention can be better understood by reference to the following claims. For purpose of claim interpretation, the transitional phrases “including” and “having” are intended to be synonymous with the transitional phrase “comprising.”

What is claimed is:

1. A sprinkler with an adjustable area of coverage, comprising:
a base comprising a supply connection for connecting the base to a water supply;
a distributor head revolvubly mounted to the base for rotating with respect to the base; and
at least two jet arms rotatably combined to the distributor head each of which jet arms comprising at least one jet nozzle in fluid communication with the supply connection for disbursing water from the water supply, wherein rotation of each of the jet arms changes the area of coverage of the sprinkler.

2. The sprinkler of claim 1, wherein the distributor head further comprises at least two oppositely extending shoulders each of which positions one of the at least two jet arms with respect to each other.

3. The sprinkler of claim 2, wherein the at least two oppositely extending shoulders each further comprise an indicator window for communicating a representation of the area of coverage of the sprinkler.

4. The sprinkler of claim 3, wherein each of the at least two jet arms further comprises a representation of the area of coverage of the sprinkler that is alignable with the indicator window of the oppositely extending shoulders, wherein rotation of the at least two jet arms changes a relative position of the representation of the area of coverage of the sprinkler with respect to the indicator window.

5. The sprinkler of claim 4, and further comprising a compression tube fitting for securing each of the at least two jet arms to one of corresponding at least two oppositely extending shoulders of the distributor head, wherein a release of the compression of the compression tube fitting allows for rotation of corresponding one of the at least two jet arms.

6. The sprinkler of claim 1, wherein each of the at least two jet arms comprises a bend having a radius.

7. The sprinkler of claim 6, wherein the at least one nozzle on each of the at least two jet arms is on the same side as an inner diameter of the radius.

8. The sprinkler of claim 7, wherein each of the at least two jet arms is rotatable to adjust an angle of inclination of the at least one nozzle on each of the at least two jet arms

9. The sprinkler of claim 8, wherein the angle of inclination is adjustable between an angle of zero degrees and an angle of ninety degrees, inclusive, to change the area of coverage of the sprinkler

10. The sprinkler of claim 2, wherein the distributor head further comprises at least two lateral discharge orifices each of which corresponds with one of the at least two shoulders, wherein the at least two lateral discharge orifices provides a path for fluid communication between the at least one jet nozzle and the supply connection.

11. The sprinkler of claim 1, and further comprising a trunnion connecting the base and the distributor head so that the distributor head rotates with respect to the base.

12. The sprinkler of claim 11, and further comprising an inner shoulder with a reduced friction surface inside the distributor head and a trunnion head on a top portion of the trunnion, wherein the trunnion head rests on the reduced friction surface inside the distributor head.

13. The sprinkler of claim 1, wherein the distributor head further comprises at least one discharge orifice at a top of the distributor head.

14. The sprinkler of claim 13, wherein the distributor head further comprises of an opening in a top with a threaded surface and a threaded cap that engages the threaded surface of the opening in the top of the distributor head and the at least one discharge orifice is in a top of the threaded cap.
